(19) United States
(12) Patent Application Publication
(10) Pub. No.: US 2025/0154021 A1
(43) Pub. Date: May 15, 2025

(54) METHOD FOR MANUFACTURING MOLYBDENUM OXYCHLORIDE AND MANUFACTURING APPARATUS THEREOF

(71) Applicant: LAKE MATERIALS Co., Ltd, Sejong-si (KR)

(72) Inventors: Joo Ho Park, Daejeon (KR); Seong-Jin Cho, Cheonan-si (KR); Kyung-Eun Lee, Sejong-si (KR); Taek-Seung Yang, Icheon-si (KR); Chang Ho Song, Cheongju-si (KR); Jin Dong Kim, Sejong-si (KR)

(21) Appl. No.: 18/946,334

(22) Filed: Nov. 13, 2024

(30) Foreign Application Priority Data
Nov. 13, 2023 (KR) 10-2023-0156736

(51) Int. Cl. C01G 39/04; B01J 19/00

(52) U.S. Cl. CPC C01G 39/04; B01J 19/0013

(57) ABSTRACT

Provided are a method for manufacturing high-purity molybdenum oxychloride and a manufacturing apparatus thereof. Specifically, provided are a method for manufacturing molybdenum oxychloride including: a reaction process of adding molybdenum powder, chlorine gas, and oxygen to a reactor and heating to prepare molybdenum oxychloride (MoO₂Cl₂); a solidification and condensation process of transferring a reacted material in the reactor from the reactor to a condensation tank to solidify the reacted material on a surface of the condensation tank; a liquefaction process of heating a product solidified in the solidification and condensation process to convert the product into a liquid phase; and a purification process of filtering the product liquefied in the liquefaction process to increase purity, and a manufacturing apparatus thereof.

### CROSS REFERENCE TO RELATED APPLICATIONS

This application claims priority under 35 U.S.C. § 119 to Korean Patent Application No. 10-2023-0156736, filed on Nov. 13, 2023, in the Korean Intellectual Property Office, the disclosure incorporated herein by reference in its entirety.

### TECHNICAL FIELD

The following disclosure relates to a method for manufacturing high-purity molybdenum oxychloride and a manufacturing apparatus thereof.

### BACKGROUND

Tungsten hexafluoride (WF₆) is the major precursor material for a semiconductor wiring process where a copper plating process is not applicable due to a high aspect ratio, i.e., 3D NAND flash. Since Tungsten hexafluoride causes difficulties during the manufacturing process, such as an increased resistance value and/or etching occurrence by residue of fluorine in a substrate, the new materials precursor development is necessary to solve these barriers and difficulties.

To Solve these difficulties and replace the former precursor materials, the innovative technology development using a molybdenum precursor in the form of molybdenum oxychloride has been completed for a semiconductor wiring process. In Korean Patent Laid-Open Publication No. 2022-0131312, a method for manufacturing molybdenum oxychloride by reacting MoO₃ powder and chlorine gas has been published. Moreover, a solution for using a glass reactor as an integrated reactor has been published. However, it is difficult to handle the glass reactor due to its fragile characteristics and inefficient productivity. It is another barrier for commercializing mass production. A process of reacting MoO3 powder and chlorine gas requires a relatively high temperature of over 800° C. since the reaction speed during the manufacturing process is delayed at lower temperatures. Therefore, there is a high demand for the development of new technology for a manufacturing method and apparatus of molybdenum oxychloride, where molybdenum metal and chlorine gas can react at lower temperatures, supporting a semi-continuous manufacturing process including semi-batch to achieve high productivity and efficiency with high purity.

### Related Art Documents

### Patent Document

(Patent Document 1) (Related Document 1) Korean Patent Laid-Open Publication No. 2022-0131312 (Sep. 27, 2022)

### SUMMARY

An embodiment of the present invention is directed to providing a method for manufacturing molybdenum oxychloride with significantly improved productivity.

Another embodiment of the present invention directed to providing a manufacturing apparatus of molybdenum oxychloride with significantly improved productivity.

Still another embodiment of the present invention directed to providing a method for manufacturing high-purity molybdenum oxychloride with increased productivity, and a manufacturing apparatus thereof.

The present inventors studied in order to solve the problem, and as a result, were able to provide new method and manufacturing apparatus for manufacturing high-purity molybdenum oxychloride. The manufacturing apparatus designed the devices using a reactor, a condensing tank, and purification system devices to manufacture high-purity molybdenum oxychloride.

By using the manufacturing apparatus, a reactant (or reacting material) may be continuously transferred to manufacturing devices including the reactor, the condensation tank, and the purification device, and recovered and purified. Therefore, the manufacturing system may support semi-continuous manufacture methods for semi-batch production. These manufacturing method and apparatus show significantly increasing productivity for high-purity molybdenum oxychloride as a final product.

In one general aspect, a method for manufacturing molybdenum oxychloride includes: a reaction process of adding molybdenum powder, chlorine gas, and oxygen to a reactor and heating to prepare molybdenum oxychloride (MoO₂Cl₂),
a solidification and condensation process of transferring a reacted material in the reactor from the reactor to a condensation tank to solidify the reacted material on a surface of the condensation tank,
a liquefaction process of heating a product solidified in the solidification and condensation process to convert the product into a liquid phase, and
a purification process of filtering the product liquefied in the liquefaction process to increase purity.

In an exemplary embodiment, the reaction process may be perform at temperature of 250 to 400° C.

In another exemplary embodiment, after the reaction process, a discharge process of cooling the reactor to solidify a product inside the reactor and discharging unreacted oxygen and chlorine using nitrogen purge and a vacuum means may be further included.

In an exemplary embodiment, a cooling temperature in the discharge process may be 0 to 100° C.

In another exemplary embodiment, the solidification and condensation process may be conducted under reduced pressure.

In an exemplary embodiment, after the solidification and condensation process in a condenser, a purification process of applying nitrogen purge or vacuum to further remove unreacted chlorine gas and side reaction products may be further included.

As another exemplary embodiment, the solidification and condensation process may be a process of, when a reactor temperature is adjusted to 120 to 400° C. or a discharge process is included, transferring the product vaporized by reheating to 120 to 400° C. to the condenser at 0 to 100° C. to solidify the product as a crystal on a surface of the condenser.

In an exemplary embodiment, after the solidification and condensation process, the liquefaction process of liquefying a product in the condenser may be liquefying by raising a condenser temperature to 110 to 250° C.

As another exemplary embodiment, the purification process performed after the liquefaction process may be purifying by filtering using a filter part including two or more filter parts having pores different from each other.

In an exemplary embodiment, the purification process may be filtering using a first filter part having pores of 5 to 50 μm and a second filter part having pores of 1 to 30 μm.

As another exemplary embodiment, the purification process may be maintaining the temperature at 180 to 250° C., preferably 180 to 220° C. so that the molybdenum oxychloride exists as a liquid phase.

In an exemplary embodiment, the molybdenum oxychloride manufactured by the manufacturing method may have a purity of 99.999 wt % or more.

In another general aspect, a manufacturing apparatus of molybdenum oxychloride includes a reactor 10, a condensation tank 20, a filter part 30 including a first filter part 31 and a second filter part 32, and a storage tank 40, which are sequentially arranged.

In an exemplary embodiment, the manufacturing apparatus of molybdenum oxychloride includes the following in a sequentially arranged manner:
a reactor which prepares crude molybdenum oxychloride by adding molybdenum powder, chlorine gas, and oxygen and heating,
a condensation tank which condenses the crude molybdenum oxychloride in a gas state transferred from the reactor into a solid phase on the surface of the condensation tank,
a filter part including a first filter part and a second filter part for removing solid impurities included in a liquefied product introduced after liquefying a product solidified in the condensation tank, and
a storage tank of the purified final product in the filter parts.

In an exemplary embodiment, the reactor 10 may include a molybdenum powder injection pipe 11, a chlorine gas injection pipe 12, an oxygen injection pipe 13, a vacuum purge, a nitrogen introduction pipe 14, and a transfer pipe 15 for transferring the reacted material in the reactor to the condensation tank 20.

As another exemplary embodiment, the condensation tank 20 may be provided with a discharge pipe 21 which may discharge impurities by nitrogen purge introduced from the reactor and a liquid transfer pipe 22 which transfers the liquefied product in the condensation tank to the filter part.

In an exemplary embodiment, the filter part 30 may sequentially include a first filter part 31 having relatively large pores and a second filter part 32 having relatively small pores.

As another exemplary embodiment, the first filter part 31 is a sintering filter having a pore size of 10 to 30 μm and the second filter part 32 is a sintering filter having a pore size of 5 to 10 μm.

In an exemplary embodiment, the filter part and the storage tank temperature may be controlled at 180 to 220° C.

Other features and aspects will become apparent from the following detailed description, the drawings, and the claims.

### BRIEF DESCRIPTION OF THE DRAWINGS

FIG. 1 is a schematic diagram of an apparatus for synthesizing molybdenum oxychloride.

### DETAILED DESCRIPTION OF MAIN ELEMENTS

100: Manufacturing apparatus
10: Reactor
11: Molybdenum powder injection pipe
12: Chlorine gas injection pipe
13: Oxygen injection pipe
14: Vacuum purge and nitrogen introduction pipe
15: Transfer pipe
20: Condensation tank
21: Discharge pipe
22: Liquid transfer pipe
30: Filter part
31: First filter part
32: Second filter part
40: Storage tank

### DETAILED DESCRIPTION OF EMBODIMENTS

Hereinafter, the present invention will be described in more detail. However, the following specific examples or exemplary embodiments are only a reference for describing the present invention in detail, and the present invention is not limited thereto, and may be implemented in various forms.

In addition, unless otherwise defined, all technical terms and scientific terms have the same meanings as those commonly understood by one of those skilled in the art to which the present disclosure pertains. The terms used herein are only for effectively describing a certain specific example and do not limit the present disclosure.

In addition, the singular form used in the specification and claims appended thereto, it intended to include a plural form, unless otherwise indicates in the context.

In addition, unless particularly described to the contrary, “comprising” any elements will be understood to imply further inclusion of other elements rather than the exclusion of any other elements.

In addition, unless particularly defined, when a layer or member is positioned on another layer or member, not only the layer or member is in contact with another layer or member, but also another layer or member exists between two layers or two members.

In addition, when unique manufacture and material allowable errors are suggested in the mentioned meaning, the terms “about”, “substantially”, and the like used in the present specification are used in the meaning of the numerical value or in the meaning close to the numerical value, and are used for preventing the disclosure mentioning a correct or absolute numerical value for better understanding of the present invention from being unfairly used by an unconscionable infringer.

A method for manufacturing molybdenum oxychloride by reacting a molybdenum metal, chlorine gas, and oxygen in an exemplary embodiment of the present invention will be described in detail below.

First, a molybdenum metal is used in a powder form to increase a contact area between gaseous chlorine and oxygen. An example of powder is not particularly limited, but for example, may have an average particle diameter (D₅₀) of 0.01 mm to 2 mm, and a smaller average particle diameter may be preferred since a reaction speed is increased. Preferably, a powder of 0.05 to 0.5 mm may be used.

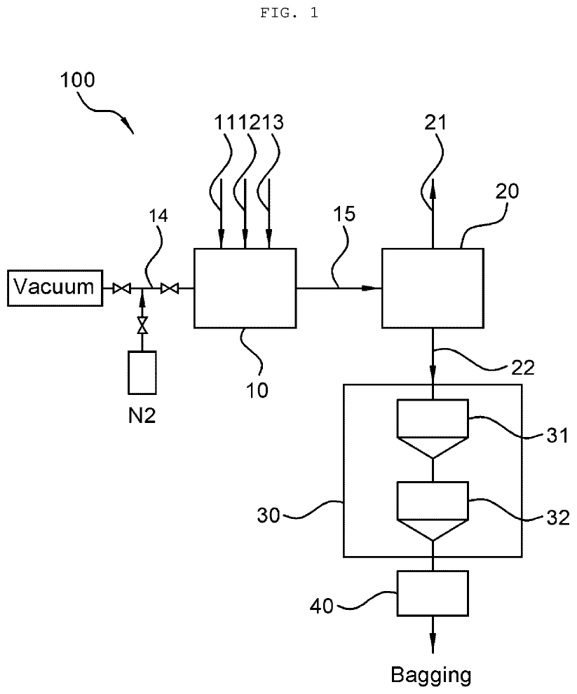

Hereinafter, the manufacturing method and the apparatus thereof may be described referring to the molybdenum oxychloride precursor manufacturing apparatus of FIG. 1. FIG. 1 shows an embodiment of the present invention, however, the manufacturing apparatus of the present invention is not limited thereto.

The manufacturing apparatus 100 of the present disclosure includes a reactor 10, a condenser 20, a filter part 30 including a first filter part 31 and a second filter part 32, and a storage tank 40, which are sequentially arranged.

More specifically, the reactor 10 which prepares crude molybdenum oxychloride by adding molybdenum powder, chlorine gas, and oxygen and heating,
the condensation tank 20 which condenses the crude molybdenum oxychloride in a gas state transferred from the reactor into a solid phase on a surface,
the filter part 30 including the first filter part 31 and the second filter part 32 for removing solid impurities included in a liquefied product introduced after liquefying a product solidified in the condensation tank, and
the storage tank 40 which stores the purified product in the filter part are included in a sequential arrangement.

First, the reactor will be described as follows.

The reactor 10 includes a molybdenum powder injection pipe 11, a chlorine gas injection pipe 12, an oxygen injection pipe 13, a vacuum purge, a nitrogen introduction pipe 14, and a transfer pipe 15 for transferring the reacted material in the reactor to the condensation tank, and the reactor may include a temperature and pressure regulating device.

The reaction temperature of the reactor may be 250 to 400° C. but is not particularly limited.

In the manufacturing apparatus, the condensation tank 20 serves to condense the product in a gas state into a solid state on the surface of the condensation tank 20 through the transfer pipe 15 of the reactor 10 and recover the product, with the temperature of the condensation tank 20 cooled to 100° C. or lower, 80° C. or lower, 60° C. or lower, 40° C. or lower, for example, −10 to 100° C., 0 to 100° C., or a temperature between the numerical values, so that the crude molybdenum oxychloride synthesized from the reactor 10 is condensed. After recovering the product, nitrogen is introduced from the reactor to purge and remove the chlorine gas and other side reaction materials in the condensation tank. In addition, the condensation tank serves to heat and liquefy the condensed product and then transfer the product in a liquid state to the filter part 30 which is the purification part and also has a function as a buffer of the reactor 10 and the filter part 30. That is, it continuously stores the reacting material of each batch of the reactor in the condensation tank and allows continuous reaction in the reactor. In order to liquefy the product condensed in the condensation tank 20, liquefaction by heating to 100 to 250° C. is needed, and a liquefaction temperature is not particularly limited as long as it is within the temperature range but may be 110 to 250° C., 120 to 220° C., or 120 to 180° C.

The condensation tank 20 may be provided with a discharge pipe 21 which may discharge impurities by nitrogen purge introduced from the reactor and a liquid transfer pipe 22 which transfers the liquefied product in the condensation tank to the filter part.

The filter part 30 removes additional solid impurities included in the product which is liquefied and introduced from the condensation tank 20. The filter part 30 may have the first filter part 31 having relatively large pores and the second filter part 32 having relatively small pores. The filter part may have one filter part having fine pores but should be replaced often with the applied filtering load, which may cause burden of process and a decrease in productivity, and thus, purification may be performed by sequentially arranging two or more filter parts having pores different from each other, and high-purity molybdenum oxychloride having a purity of 99.999 wt % or more may be provided by the purification filter.

The first filter part 31 may be a filter having a pore size of 5 to 50 μm, and the second filter part 32 may have a pore size of 1 to 30 μm, preferably 1 to 20 μm, and more preferably 5 to 10 μm or a size between the numerical values. That is, the pore size of the first filter part 31 may be larger than the pore size of the second filter part 32.

The temperature of the filter part is not specified as long as the molybdenum oxychloride exists safely as a liquid phase, and is preferably maintained, for example, at 150 to 250° C., preferably 180 to 220° C., and more preferably 200° C. for a filtering effect.

The material of the filters of the filter part is not particularly limited and is not restricted as long as it is a material stable for molybdenum oxychloride, and preferably, it is preferred to use a sintering filter in terms of stability.

The product purified in the filter part 30 is stored in the storage tank in a liquefied state even when it is maintained the same as or different from the temperature of the filter part in the storage tank 40, and then may be bagged in a liquid form, and after being bagged, solidified and sold in a bagged state at room temperature.

Hereinafter, the manufacturing method will be described.

The manufacturing method of the present disclosure may provide a method for manufacturing molybdenum oxychloride (MoO₂Cl₂) including: a reaction process of adding molybdenum powder, chlorine gas, and oxygen to a reactor and heating to prepare molybdenum oxychloride (MoO₂Cl₂),
a solidification and condensation process of transferring a reacted material in the reactor from the reactor to a condensation tank to solidify the reacted material on a surface of the condensation tank,
a liquefaction process of heating a product solidified in the solidification and condensation process to convert the product into a liquid phase, and
a purification process of filtering the product liquefied in the liquefaction process to increase purity.

The molybdenum oxychloride (MoO₂Cl₂) prepared in the reaction process may be crude molybdenum oxychloride.

The temperature of the reaction process is not particularly limited as long as the reaction is possible at the temperature but for example, may be 250 to 400° C.

In an exemplary embodiment, after the reaction process, a discharge process of cooling the reactor to solidify the product and discharge unreacted oxygen and chlorine using nitrogen purge and a vacuum means may be further included. The cooling temperature is not particularly limited as long as the product is solidified inside the reactor at the temperature, but for example, may be 0 to 100° C.

In the manufacturing method of another exemplary embodiment, the solidification and condensation process may be carried out under reduced pressure. Since the product is easily transferred from the reactor to the condensation tank and allows the product to be solidified on the surface of the condensation tank under reduced pressure, it is more preferred.

The condenser on the surface of which the molybdenum oxychloride is solidified may further remove unreacted chlorine gas and side reaction products, for example, metal chlorides such as tungsten chloride from a reaction of tungsten included in the molybdenum metal and various impurity metals by applying nitrogen purge or vacuum at a solidification temperature.

As an exemplary embodiment, the solidification and condensation process may be transferring the product vaporized at the temperature of the reactor, or when the discharge process is included, vaporized by reheating to 120 to 400° C. to the condenser at 0 to 100° C. and solidifying the product as a crystal on the surface of the condenser.

After the product is solidified or both solidified and purified in the solidified condenser, a liquefaction process of heating and liquefying the solidified product of the condenser is carried out. The temperature range during heating in the liquefaction process may be 110 to 250° C., and a liquefaction temperature is not particularly limited as long as it is within the temperature range but may be liquefaction by heating to preferably 110 to 220° C. or 120 to 180° C.

The liquefied product is transferred to the filter part and filtered to undergo a purification process. The purification process is carried out by filtering in two or more filter parts having pores different from each other, thereby completing the purification process.

In the purification process, purification is carried out in the filter part including the first filter part having pores of 5 to 50 μm and the second filter part having pores of 1 to 30 μm to provide molybdenum oxychloride (MoO₂Cl₂) having a purity of 99.9999% or more. The first filter part may have a larger pore size than the second filter part.

Another exemplary embodiment further includes bagging molybdenum oxychloride (MoO₂Cl₂), after the filtering process.

An exemplary embodiment may be a method for manufacturing MoO₂Cl₂ in which the temperature from the filtering process to the bagging process is maintained at 180 to 220° C. so that MoO₂Cl₂ remains as a liquid phase.

Another exemplary embodiment may be a manufacturing method in which when unreacted oxygen and chlorine are discharged in the discharge process, they are discharged by nitrogen purging.

In another embodiment of the present disclosure, the molybdenum oxychloride may have a purity of 99.999 wt % or more by the manufacturing method.

In the present disclosure, after the product is transferred from the reactor to the condensation tank, the inside of the reactor is cleaned by purging, molybdenum powder, chlorine gas, and oxygen are added again and reacted, and simultaneously the solidified product in the condensation tank is continuously subjected to a later step by the liquefaction and purification processes and available for shipment, and thus, the productivity may be significantly increased and products having excellent purity may be manufactured.

Hereinafter, the present disclosure will be described in detail using the following examples. However, the following examples illustrate a specific example for understanding the technical contents of the present invention, and the present disclosure is not limited by the following examples.

An average particle diameter refers to D₅₀, and D₅₀ refers to a particle diameter of a particle corresponding to 50% in terms of a volume-based integrated fraction. The average particle diameter may be derived from particle size distribution results obtained by collecting a sample of particles to be measured in accordance with the standard of ISO 13320-1 and performing analysis using S3500 available from MICROTRAC.

Purity was analyzed using ICP_MS (Agilent, ICP-MS 7900 s).

0.1 g of a sample was collected in a 100 ml HDPE bottle using a spatula, with exclusive N₂ gas replaced with an acryl glove box. The weight of the collected sample was measured with precision using a scale capable of measuring to four decimal places.

A mixed acid of 2% HNO₃ and 1% HF was prepared, and 50 g of the mixed acid was added to a sampled HDPE bottle. After adding the mixed acid, the weight was measured again using the scale capable of measuring to four decimal places and recorded.

The sample to which the mixed acid was added was sonicated for 10 minutes using an ultrasonic cleaner.

Analysis was performed using ICP-MS 7900 s equipment. For this, the standard solution of the analysis instrument was prepared, a calibration curve was secured, and the quantitative analysis of the sample was performed. Metals measured in the present analysis included Ag, Al, As, Au, Ba, Ca, Co, Cr, Cu, Fe, K, Li, Mg, Mn, Na, Ni, Pb, Sn, V, W, and Zn.

### Example 1

Molybdenum metal powder having an average particle diameter (D₅₀) of 0.1 mm was filled into a reaction vessel to a volume of ⅕ and heated at 350° C., and then chlorine gas and oxygen were added from a gas supply pipe to synthesize MoO₂Cl₂. Vaporized MoO₂Cl₂ was transferred to a condensation tank controlled at 60° C. to sufficiently solidify the product on the surface of the condensation tank. Subsequently, vacuum (30 torr) was applied from the reactor to discharge unreacted chlorine gas and impurities. Purge was introduced from the reactor again to purge nitrogen to the condensation tank and discharge nitrogen from the condensation tank, thereby removing residual unreacted substances and impurities. At this time, as a result of analyzing the purity of the molybdenum oxychloride using ICP_MS, the purity was 99.99 wt %.

Subsequently, the reactor and the condensation tank were blocked, an additional batch reaction was carried out in the reactor by adding molybdenum metal powder again and adding oxygen and chlorine gas, and simultaneously the reacted material in the condensation tank which liquefied the reacted material was blocked from the outside of the condensation tank and heated to a temperature of 200° C. to perform liquefaction. Thereafter, filtration has been carried out by continuously passing through a first filter which was a sintering filter having pores of 10 μm and a second sintering filter having pores of 5 μm. The resulting purity of molybdenum oxychloride was 99.9998 wt %.

According to the present disclosure, a method for manufacturing a molybdenum oxychloride precursor having the same effect as semi-batch, and a manufacturing apparatus may be provided.

In addition, since the reaction process and the purification process operate separately, a new reaction may be carried out even during the purification process to increase production.

In addition, in order to recover a reacted material between the reaction process and the purification process and transfer the reacted material to the purification process, a waiting condensation tank is separately provided, so that the molybdenum oxychloride solidified on the surface of the condensation tank is purged with nitrogen again to remove unreacted chlorine and other impurities, thereby further increasing purity.

In addition, according to the present manufacturing method, the first filter part and the second filter part are sequentially connected to filter impurities, thereby increasing the purity to 99.999% or more.

What is claimed is:

1. A method for manufacturing molybdenum oxychloride, the method comprising:
a reaction process of adding molybdenum powder, chlorine gas, and oxygen to a reactor and heating to prepare molybdenum oxychloride (MoO₂Cl₂),
a solidification and condensation process of transferring a reacted material in the reactor from the reactor to a condensation tank to solidify the reacted material on a surface of the condensation tank,
a liquefaction process of heating a product solidified in the solidification and condensation process to convert the product into a liquid phase, and
a purification process of filtering the product liquefied in the liquefaction process to increase purity.

2. The method for manufacturing molybdenum oxychloride of claim 1, wherein the reaction process is carried out at 250 to 400° C.

3. The method for manufacturing molybdenum oxychloride of claim 1, further comprising: after the reaction process, a discharge process of cooling the reactor to solidify the product and discharge unreacted oxygen and chlorine using nitrogen purge or a vacuum means.

4. The method for manufacturing molybdenum oxychloride of claim 3, wherein a cooling temperature is 0 to 100° C.

5. The method for manufacturing molybdenum oxychloride of claim 1, wherein the solidification and condensation process are carried out under reduced pressure.

6. The method for manufacturing molybdenum oxychloride of claim 1, further comprising: after the solidification and condensation process, a purification process of applying nitrogen purge or vacuum to further remove unreacted chlorine gas and side reaction products.

7. The method for manufacturing molybdenum oxychloride of claim 1, wherein the solidification and condensation process is, when a reactor temperature is adjusted to 120 to 400° C. or the discharge process is included, transferring the product vaporized by reheating to 120 to 400° C. to the condenser at 0 to 100° C. to solidify the product as a crystal on a surface of the condenser.

8. The method for manufacturing molybdenum oxychloride of claim 1, wherein the liquefaction is carried out by raising a condenser temperature in the liquefaction process to 110 to 250° C.

9. The method for manufacturing molybdenum oxychloride of claim 1, wherein the purification process is filtering using two or more filters having pores different from each other.

10. The method for manufacturing molybdenum oxychloride of claim 9, wherein the purification process is filtering using a first filter part having pores of 5 to 50 μm and a second filter part having pores of 1 to 30 μm.

11. The method for manufacturing molybdenum oxychloride of claim 1, wherein the purification process is maintained at 180 to 250° C. so that the molybdenum oxychloride exists as a liquid phase.

12. The method for manufacturing molybdenum oxychloride of claim 1, wherein the molybdenum oxychloride manufactured by the method has a purity of 99.999 wt % or more.

13. A manufacturing apparatus of molybdenum oxychloride comprising:
a reactor which prepares crude molybdenum oxychloride by adding molybdenum powder, chlorine gas, and oxygen; and heating,
a condensation tank which condenses the crude molybdenum oxychloride in a gas state transferred from the reactor into a solid phase on the surface of the condensation tank,
a filter part including a first filter part and a second filter part for removing solid impurities included in a liquefied product introduced after liquefying a product solidified in the condensation tank, and
a storage tank which stores the product purified in the filter part,
which are sequentially arranged.

14. The manufacturing apparatus of molybdenum oxychloride of claim 13, wherein the reactor includes a molybdenum powder injection pipe; a chlorine gas injection pipe; an oxygen injection pipe; a vacuum purge and nitrogen introduction pipe; and a transfer pipe which transfers a reacted material of the reactor to the condensation tank.

15. The manufacturing apparatus of molybdenum oxychloride of claim 13, wherein the condensation tank is provided with a discharge pipe capable of discharging impurities by nitrogen purge introduced from the reactor and a liquid transfer pipe which transfers the liquefied product in the condensation tank to the filter part.

16. The manufacturing apparatus of molybdenum oxychloride of claim 13, wherein the filter part sequentially includes a first filter part having relatively large pores and a second filter part having relatively small pores.

17. The manufacturing apparatus of molybdenum oxychloride of claim 16, wherein the first filter part is a sintering filter having a pore size of 10 to 30 μm and the second filter part is a sintering filter having a pore size of 5 to 10 μm.

18. The manufacturing apparatus of molybdenum oxychloride of claim 13, wherein the filter part and the storage tank are maintained at 180 to 220° C.
